(19) United States
(12) Patent Application Publication
(10) Pub. No.: US 2025/0128190 A1
(43) Pub. Date: Apr. 24, 2025

(54) ELECTROWETTING COALESCENCE DEVICE FOR USE WITH ORGANIC PROCESS FLUIDS

(71) Applicants: The University of Akron, Akron, OH (US); BASF Corporation, Florham Park, NJ (US)

(72) Inventors: Tinoush DINN, Beachwood, OH (US); George CHASE, Wadsworth, OH (US); Mohammad ASSALEH, Stow, OH (US); Jack BENDER, Vail, AZ (US); Amit GOKHALE, Houston, TX (US); William C. MAYS, Southfield, MI (US); Martin Lawrence PANCHULA, Beachwood, OH (US)

(21) Appl. No.: 18/837,500

(22) PCT Filed: Feb. 10, 2023
(86) PCT No.: PCT/US2023/012799

§ 371 Date: Aug. 9, 2024

Related U.S. Application Data
(60) Provisional application No. 63/309,087, filed on Feb. 11, 2022.

(51) Int. Cl. B01D 17/06; B01D 17/04

(52) U.S. Cl. CPC B01D 17/06; B01D 17/045

(57) ABSTRACT

An electrowetting coalescing device is disclosed, which device can be utilized for coalescing droplets of a dispersed phase within a continuous phase of an organic process fluid. The electrowetting coalescing device coalesces smaller droplets of the dispersed phase into larger droplets of the dispersed phase for subsequent removal of the larger droplets from the continuous phase. A method for coalescing droplets is also disclosed. A method of designing an electrowetting coalescing device with a mechanistic model is also disclosed.

### CROSS REFERENCE TO RELATED APPLICATIONS

This application claims the benefit of U.S. provisional patent application Ser. No. 63/309,087, filed Feb. 11, 2022, which is incorporated by reference herein.

### FIELD OF THE INVENTION

One or more embodiments of the invention are directed toward an electrowetting coalescence device. The electrowetting coalescence device may be useful for coalescing droplets of a dispersed phase within a continuous phase of an organic process fluid.

### BACKGROUND

U.S. Publication No. 2020/0094167 discloses an electrowetting coalescence device for coalescing droplets of a dispersed phase within a continuous phase. The electrowetting coalescence (EWC) device of the '167 Pub. is disclosed as being useful for separating water from diesel fuel. The stainless steel (SS) mesh EWC includes bolts to make electrical contact with the mesh to apply the desired voltage. With the low conductivity diesel fuel and deionized water used in the '167 Pub., the EWC performs sufficiently. But for certain organic process fluids, the applied potential difference between the mesh electrodes of the EWC of the '167 Pub. generally cannot be sustained with low current because of electrical short-circuiting.

Separation of a dispersed phase (e.g., an aqueous phase) from an organic process fluid can be challenging. Certain of these fluids include one or more of carboxylic acids, amines, aldehydes, ketones, and alcohols. Other difficult to treat organic process fluids include those with metal ions. This difficulty can arise due to the charge of some of the compounds found in such fluids. In this same light, prior literature on electrowetting generally involves avoiding conductive fluids, that is, fluids having compounds that dissociate into ions. An example is sodium acetate, where the sodium acetate can dissociate into sodium and acetate ions. A further challenge in the separation of an aqueous phase from an organic phase is safety, especially relative to the treatment of fluids with electrical current, which may or may not have intrinsic charge. Another challenge is the practical configuration of managing a facility with potential volatile liquids and electricity.

These types of organic process fluids are difficult to treat. The application of an external electric field to droplets suspended in an immiscible fluid generally leads to the droplets becoming polarized and forming opposite charges at the ends. Due to Maxwell stress, the spherical droplets can become ellipsoid in shape. Collision of the droplets can then lead to a thin bridge forming between the joined droplets. As droplets collide and form the bridge, ions accumulated on the drop interface can migrate onto the adjacent interface, which results in Columbic repulsion between identical ions. This Coulombic repulsion and the electrostatic forces tend to pull two droplets in opposite directions, leading to the breakage of the bridge, which may also be referred to as recoil. And under these principles, droplets with high conductivity are more inclined to recoil. While increasing electric field strength may assist with avoiding recoil and promoting droplet coalescence, the critical field strength (above which the droplets will generally recoil) tends to decrease with increasing conductivity.

There remains a need in the art for an improved electrowetting coalescence device for processing organic process fluids.

### SUMMARY

In one embodiment, the present invention provides an electrowetting coalescing device for coalescing droplets of a dispersed phase within a continuous phase of an organic process fluid, the electrowetting coalescing device including an inlet; a porous first electrode with a first independent electrical connection thereto, the porous first electrode including a first plurality of pores having a first average pore size; a porous second electrode with a second independent electrical connection thereto, the porous second electrode including a second plurality of pores having a second average pore size, where the second average pore size is different from the first average pore size; a voltage applied and maintained to the porous first electrode, where the porous second electrode is at a second voltage different from the voltage applied and maintained to the porous first electrode, where the second voltage is optionally a 0 V ground, thereby creating an electric field between the porous first electrode and the porous second electrode; an outlet; and the organic process fluid, the organic process fluid including the dispersed phase within the continuous phase, the continuous phase including an organic fluid loaded with metal, and the dispersed phase including aqueous droplets which optionally include further metal ions or acid salts, the dispersed phase being conductive or non-conductive, the continuous phase having a low conductivity; the electrowetting coalescing device receiving the organic process fluid, the organic process fluid passing through the inlet, the porous first electrode, the electric field, the porous second electrode, and the outlet, the electrowetting coalescing device thereby coalescing smaller droplets of the dispersed phase into larger droplets of the dispersed phase for subsequent removal of the larger droplets from the continuous phase.

In another embodiment, the present invention provides a method for coalescing droplets of a dispersed phase within a continuous phase of an organic process fluid in an electrowetting coalescing device, the method including providing the electrowetting coalescing device; providing the organic process fluid, the organic process fluid including the dispersed phase within the continuous phase, the continuous phase including an organic fluid loaded with metal, and the dispersed phase including aqueous droplets which optionally include further metal ions or acid salts, the dispersed phase being conductive or non-conductive, the continuous phase having a low conductivity; allowing the organic process fluid to flow through the electrowetting coalescing device; allowing the droplets of the dispersed phase to electrowet to form larger droplets; and removing the larger droplets from the continuous phase.

In another embodiment, the present invention provides a method of designing an electrowetting coalescing device, the method including steps of providing an organic process fluid, the organic process fluid including a dispersed phase within a continuous phase, the continuous phase including an organic fluid loaded with metal, and the dispersed phase including aqueous droplets which optionally include further metal ions or acid salts; providing a mechanistic model, where the mechanistic model comprises:

$$\frac{dS}{dt} = ( {c}_{o} + {f}_{o} E ) \frac{Q}{ρ V} - \frac{RQ}{V} \qquad Equation ( 3 )$$

$$f = {f}_{o} - {f}_{o} E \qquad Equation ( 4 )$$

$$c = {c}_{o} + {f}_{o} E \qquad Equation ( 5 )$$

$$E = a S + {E}_{o} \qquad Equation ( 6 )$$

$$R = b {S}^{n} , \qquad Equation ( 7 )$$

where E is the capture efficiency of the electrowetting coalescing device and represents an effectiveness at which smaller droplets are converted into larger droplets for collection thereof, R is a release coefficient and represents an ability of the larger droplets to release from the electrowetting coalescing device, S is a water saturation content, and a, E_{O}, b, and n are fitted parameters; where Q is a volumetric flow rate through the EWC, V is a volume of the EWC, and ρ is a mass density of the dispersed phase; where concentrations of the smaller droplets and the larger droplets drops entering the EWC are ƒₒ and cₒ, and concentrations of the smaller droplets and the larger droplets drops exiting the EWC are ƒ and c; and manufacturing the desired electrowetting coalescing device based on the mechanistic model and properties of the predetermined organic process fluid.

### BRIEF DESCRIPTION OF THE DRAWINGS

Advantages of the present invention will become better understood with regard to the following description, appended claims, and accompanying drawings wherein:

FIG. 1 is a cross-sectional schematic of an electrowetting coalescence device according to one or more embodiments of the present invention;

FIG. 2 is an exploded view of the electrowetting coalescence device of FIG. 1;

FIG. 3 is a perspective view of the electrowetting coalescence device of FIG. 1;

FIG. 4 is a schematic showing multiple electrowetting coalescence devices in a manifolded configuration according to one or more embodiments of the present invention;

FIG. 5 is a schematic showing multiple electrowetting coalescence devices in a successive configuration, with a separator between respective electrowetting coalescence devices, according to one or more embodiments of the present invention;

FIG. 6 is a schematic showing multiple electrowetting coalescence devices in a successive configuration, without a separator between respective electrowetting coalescence devices, according to one or more embodiments of the present invention;

FIG. 7 is a schematic showing an electrowetting coalescence device including a first electric field between a first electrode and a second electrode, and a second electric field between the second electrode and a third electrode, according to one or more embodiments of the present invention;

FIG. 8 is a top plan view of a perforated plate, which can be used as an electrode for an electrowetting coalescence device, according to one or more embodiments of the present invention;

FIG. 9 is a perspective view of sub-components of an electrowetting coalescence device including three perforated plates, according to one or more embodiments of the present invention;

FIG. 10 is an alternate perspective view of an electrowetting coalescence device including three perforated plates, according to one or more embodiments of the present invention;

FIG. 11 is a cross-sectional view of the electrowetting coalescence device of FIG. 10; and

FIG. 12 is a top plan view of an electrowetting coalescence device with alternative electrode connection locations, according to one or more embodiments of the present invention.

### DETAILED DESCRIPTION

Embodiments of the invention are based, at least in part, on an electrowetting coalescence (EWC) device. In use, the electrowetting coalescence device receives a fluid for processing thereof, and the electrowetting coalescence device can be particularly useful for processing organic process fluids. The electrowetting coalescence device includes one or more porous layers, such that the fluid passes through pores of the one or more porous layers. Advantageously, the electrowetting coalescence device is effective at separating aqueous droplets containing salts (e.g., one or more of metal ions and acid salts) from organic process fluids, which also may contain one or more of metal ions and metal complexes. Where present, the ions can make these fluids more electrically conductive than deionized water and diesel fuel. As discussed further herein, present results show organic process fluids can be electrowetted and separated using the EWC device of one or more embodiments of the present invention.

The electrowetting coalescence device, which may be referred to herein as an EWC, an EWC device, or a device, includes a first electrode and a second electrode, where a voltage difference exists between the first electrode and the second electrode to thereby generate an electric field. The electrowetting coalescence device can include one or more additional electrodes, where a voltage difference exists between each respective pair of electrodes to thereby generate respective electric fields. As generally known to the skilled person, an electrode is a conductor through which electricity enters or leaves an object, substance, or region. An electrode may also be referred to as an electrical conductor that makes contact with, and carries electric current to, a nonmetallic part of a circuit.

As mentioned above, the electrowetting coalescence device includes one or more porous layers. In one or more embodiments, the porous layers are the electrodes. That is, in one or more embodiments, a first porous layer may be employed as the first electrode and a second porous layer may be employed as the second electrode. In other embodiments, a housing may serve as an electrode, in conjunction with one or more porous layers as an electrode. That is, in these other embodiments, a first porous layer may be employed as the first electrode and a housing may be employed as the second electrode.

A voltage difference exists between the first electrode and the second electrode, and where a third electrode is present, between the second electrode and the third electrode, and so on, to thereby generate one or more electric fields in the electrowetting coalescence device. As generally understood by the skilled person, a voltage difference between respective electrodes may be accomplished in a variety of manners. For example, an electric field may be achieved by utilizing a first electrode provided with an applied voltage such that the first electrode is employed as a positive electrode, and a second electrode that is grounded and employed as a grounded electrode. Electric fields may also be achieved between a negative electrode and a grounded electrode, between a positive electrode and a negative electrode, between a positive electrode and a less-positive electrode, and between a negative electrode and a more-negative electrode. Any of these embodiments may be utilized with the electrowetting coalescing devices described herein, so long as one or more suitable electric fields are generated. In embodiments not having a grounded electrode, it is desirable to ground the external housing or another component for safety purposes.

As suggested above, a fluid (e.g., an organic process fluid) having a continuous phase and a dispersed phase, in the form of small droplets, can be provided to the electrowetting coalescence device, particularly to an inlet thereof, and subsequently to the one or more porous layers. That is, all of the flow of the fluid passing through the EWC passes through the one or more porous layers and the one or more electric fields. The small droplets will generally be micron sized, and while the micron sized droplets will initially be much smaller than pore openings of the one or more porous layers, the one or more electric fields cause most of the droplets to be attracted to the surface of the one or more porous layers. Other of the droplets can spread on the surface of the porous layers and a minor amount of the small droplets may pass through without being captured, especially at relatively higher flow velocity.

As further description of the coalescence mechanism, the one or more electric fields generated by respective pairs of electrodes promotes coalescence of droplets of the dispersed phase (e.g., water) by increasing the attractive force between the droplets. The coalescence of the dispersed phase droplets generally includes two or more dispersed phase droplets coming together, the droplets staying in contact for sufficient duration, and a thin film of continuous phase existing between the droplets rupturing, thereby forming a larger droplet from the two or more dispersed phase droplets. The electric field may modify the wetting properties of the one or more porous layers based on the principles of electrowetting, thereby improving the adherence of the dispersed phase droplets on the surfaces of the porous layers. The porous layers provide increased surface area for the fluid to contact, thereby giving more area for contact of the dispersed phase droplets.

Said another way, small droplets will continue to attract to the first porous layer and will begin to grow by electrocoalescence and collision of small droplets with other small droplets. The small droplets may be one or more of electrolytic, polarizable, or otherwise capable of conducting current or being electrically charged. Where the small droplets are water (e.g., deionized water), they may be non-electrolytic. Based on the presence of the electric field, and the corresponding principles, which are generally known to the skilled person, the small droplets will be attracted to the first porous layer, such as by the forces that result from the applied electric field. The growth of the small droplets will continue until the combined droplets, formed from a plurality of smaller droplets, are carried away when the gravity force or the drag force of the flow of the continuous phase is dominant over the electrical attraction.

These combined droplets, which may also be referred to as larger droplets, then proceed to the second porous layer. In order to account for the larger size of larger droplets, and to thereby coalesce and collect larger droplets, the second porous layer may have pore sizing that is greater than the pore sizing of first porous layer. Though in other embodiments, the second porous layer may have pore sizing that is smaller than the pore sizing of first porous layer. These combined droplets may also be one or more of electrolytic, polarizable, or otherwise capable of conducting current or being electrically charged. These combined droplets may also be non-electrolytic. Based on the presence of the electric field, and the corresponding principles, the combined droplets will be attracted to the second porous layer, such as by the forces that result from the applied electric field. That is, the second porous layer achieves further coalescence of the combined droplets produced from the first porous layer.

These combined droplets will continue to attract to the second porous layer and will begin to grow by electrocoalescence and collision of the combined droplets with other combined droplets. This growth will continue until the exit droplets formed from a plurality of combined droplets are carried away when the gravity force and/or the drag force of the flow of the continuous phase is dominant over the electrical attraction. Where the second porous layer has pore sizing that is smaller than the pore sizing of first porous layer, this may include certain breakage of the exit droplets back into smaller droplets. Though these smaller droplets should remain of sufficient size as to still be suitably collected.

The exit droplets, which may also be referred to as collected droplets or largest droplets, pass through the second porous layer and to an outlet. The collected droplets may be collected in a drain for eventual removal of the largest droplets. In these or other embodiments, the flow from the outlet may be provided to a downstream apparatus for removal of the collected droplets from the continuous phase. Exemplary downstream apparatuses may include membranes, molecular sieving, barrier filters, gravity settlers, centrifugal inertial separators, or other separators. The above described process then repeats as new amounts of the fluid are provided to the EWC device.

Further details of the one or more porous layers are now provided. The porous layers may be any suitable two-dimensional-type or three-dimensional-type structures. An exemplary two-dimensional-type structure is a sheet. Exemplary three-dimensional-type structures include a ball (e.g. steel wool ball) and an encased multi-layer grid (e.g. metal grid). The porous layers may be woven or non-woven. Other examples for the one or more porous layers include woven and non-woven mesh, perforated plates, porous sintered metal, and parallel layered metal strips. An examples of parallel layered metal strips includes wedge shaped metal layers that create rectangular slot openings as pores.

In one or more embodiments, the porous layers may be mesh. Mesh may be defined as having one or more of attached and woven strands. In one or more embodiments, the mesh may be wire mesh. In one or more embodiments, the porous layers are woven mesh, such as woven metal mesh. An exemplary woven metal mesh is stainless steel woven mesh. In one or more embodiments, the porous layers may be non-woven randomly oriented fibers.

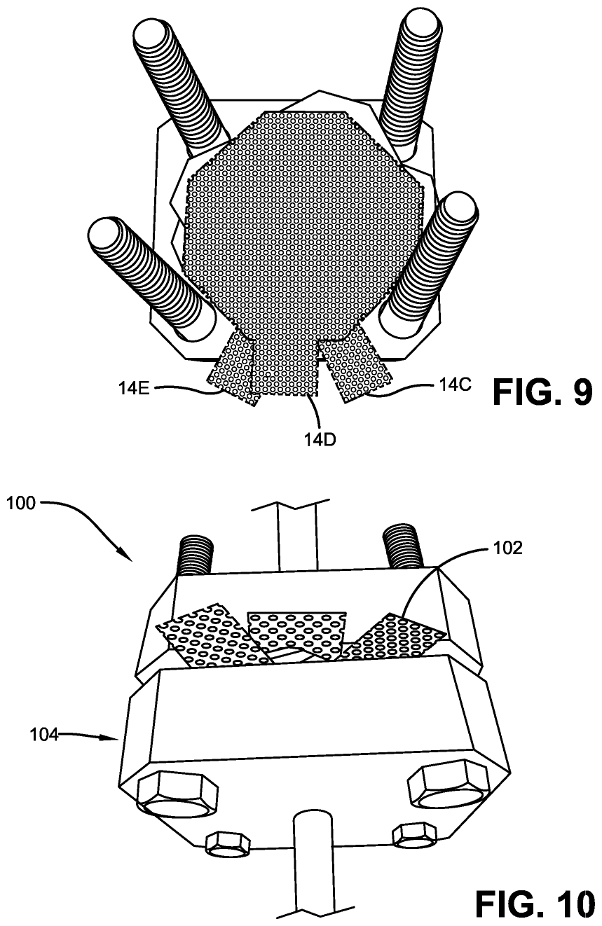

In one or more embodiments, the porous layers may be perforated plates, which may also be referred to as perforated sheets. In one or more embodiments, the perforated plates may be metal. An exemplary metal is stainless steel. As shown in FIG. 8, in one or more embodiments, the holes of perforated plates may be square shaped. As shown in FIG. 9, in one or more embodiments, the holes of perforated plates may be circular shaped.

While both mesh and perforated plates, among other suitable porous layers, perform well as electrodes, the design of the one or more porous layers may depend on the desired features for any given EWC device and/or fluid. Mesh tends to be more flexible, depending on the diameter of the material used to make the mesh. Mesh tends to have smaller pores. Plates tend to be stiffer and not bend as easily, which can reduce the chance of plates touching each other relative to mesh. Perforated plates may offer more uniformity relative to pore size. For relatively larger EWC devices, stiffer mesh and/or plates may need to be used in order to prevent deformation and contact. For EWC devices with relatively larger gap distance, and where mesh is preferred, a nonconductive spacer may be present between the mesh electrodes in order to prevent contact. Any of these design parameters may be utilized relative to selecting a desired EWC device for a given fluid.

The pores of the one or more porous layers described herein may be formed by any suitable technique. In one or more embodiments, porous layers may be formed by perforating a substrate to provide the substrate with pores. In one or more embodiments, the porous layers may be formed by sintering, such as sintering metal sheets made from small metal particles sintered together. Where the porous layers are mesh, the pores are formed as part of making the mesh.

As used herein, the term porous layer is to be interpreted broadly as including at least one layer of porous material. In one or more embodiments, a porous layer may be embodied by a plurality of layers of porous material. As used herein, the term porous layer may be defined as including one or more layers of porous material that allow the flow of a fluid to pass therethrough, and which allow the described electrowetting coalescence function.

The porous layers may be characterized by the dimensions thereof, such as thickness, length, width, and diameter, though the porous layers may have any suitable dimensions. In one or more embodiments, porous layers may have a thickness of from about 0.5 mm to about 5 mm, in other embodiments, from about 0.5 mm to about 3 mm, and in other embodiments, from about 1 mm to about 3 mm.

In one or more embodiments, porous layers may have a length or diameter of from about 0.01 m to about 100 m, in other embodiments, from about 0.05 m to about 10 m, and in other embodiments, from about 0.1 m to about 0.5 m.

The porous layers may be characterized by pore size. In one or more embodiments, porous layers may be characterized by the pore size of a first porous layer relative to the pore size of a second porous layer. In one or more embodiments, each subsequent porous layer in the flow path may have pore sizing that is greater than the pore sizing of the prior porous layer. In other embodiments, each subsequent porous layer in the flow path may have pore sizing that is smaller than the pore sizing of the prior porous layer. In still other embodiments, all porous layers have relatively similar pore sizing.

Relative to pore size and other characteristics disclosed herein, the mechanism of coalescence of the droplets should be considered in conjunction with the mechanism of collecting the droplets. That is, pore size and other characteristics may be adjusted in order to achieve the two mechanisms working best together.

In one or more embodiments, the pore size ranges from about 0.05 mm to about 10 mm, in other embodiments, from about 0.1 mm to about 5 mm, in other embodiments, from about 0.1 mm to about 3 mm, in other embodiments, from about 0.5 mm to about 2 mm. In one or more embodiments, the pore size is about 0.5 mm, in other embodiments, about 1 mm, in other embodiments, about 2 mm, and in other embodiments, about 5 mm. These pore sizes are applicable for both the inlet pore sizes and outlet pore sizes, in addition to the further disclosed pore sizes below. Pore sizes disclosed herein are applicable for both the porous layers as mesh and as perforated plates. Where the porous layers are perforated plates, the pore size may also be referred to as the diameter of the perforated holes.

In one or more embodiments, the pore size of the outlet porous layer ranges from about 1 mm to about 1.5 mm, in other embodiments, from about 1 mm to about 1.3 mm, and in other embodiments, from about 1.1 mm to about 1.2 mm. In one or more embodiments, the pore size of the outlet porous layer is about 1 mm, in other embodiments, about 1.1 mm, in other embodiments, about 1.18 mm, and in other embodiments, about 1.2 mm.

In one or more embodiments, the pore size of the inlet porous layer ranges from about 0.3 mm to about 1 mm, in other embodiments, from about 0.5 mm to about 0.9 mm, and in other embodiments, from about 0.6 mm to about 0.8 mm. In one or more embodiments, the pore size of the inlet porous layer is about 0.5 mm, in other embodiments, about 0.7 mm, in other embodiments, about 0.9 mm, and in other embodiments, about 1 mm.

Pore size may be characterized relative to the ratio between the pore size and the size of the droplets. In one or more embodiments, the pore size of the inlet porous layer ranges from about 10 times to about 1,000 times, in other embodiments, from about 50 times to about 750 times, and in other embodiments, from about 100 times to about 500 times, the size of the inlet droplets. In one or more embodiments, the pore size of the inlet porous layer is about 50 times, in other embodiments, about 100 times, in other embodiments, about 250 times, and in other embodiments, about 500 times, the size of the inlet droplets.

In one or more embodiments, the pore size of the outlet porous layer ranges from about 0.1 times to about 2 times, in other embodiments, from about 0.5 times to about 2 times, and in other embodiments, from about 0.5 times to about 1.5 times, the size of the outlet droplets. In one or more embodiments, the pore size of the outlet porous layer is about 0.5 times, in other embodiments, about 1 time, in other embodiments, about 1.5 times, and in other embodiments, about 2 times, the size of the outlet droplets.

Pore size may be characterized relative to the ratio between the inlet pore size and the outlet pore size. In one or more embodiments, the pore size of the inlet porous layer ranges from about 0.1 times to about 10 times, in other embodiments, from about 0.5 times to about 5 times, and in other embodiments, from about 0.5 times to about 2 times, the pore size of the outlet porous layer. In one or more embodiments, the pore size of the inlet porous layer is about 0.1 times, in other embodiments, about 0.5 times, in other embodiments, about 2 times, and in other embodiments, about 5 times, the pore size of the outlet porous layer.

In embodiments where the porous layers are perforated plates, pore size may be defined by open area, which may also be referred to as area fraction, which refers to the open area of the holes compared with the area of the solid plate, and is between 0 and 1 or as a percentage between 0% and 100%. The porous layers may have any desired open area within the range from 0 and 1. In one or more embodiments, porous layers have an open area of from 0.01 to 0.99, in other embodiments, 0.2 to 0.8, in other embodiments, from 0.3 to 0.7, and in other embodiments, from 0.4 to 0.6.

In embodiments where the porous layers are mesh, pore size may be defined by porosity, which is a measure of the void spaces in a material, and is a fraction of the volume of voids over the total volume, and is between 0 and 1 or as a percentage between 0% and 100%. In one or more embodiments, porous layers have a porosity of from 0.15 to 0.9, in other embodiments, 0.3 to 0.8, and in other embodiments, from 0.4 to 0.6.

In embodiments where the porous layers are mesh, pore size may be characterized by mesh count, which refers to the number of openings per linear inch. In one or more embodiments, porous layers have a mesh count of 40×40 or less, in other embodiments, 30×30 or less, in other embodiments, 20×20 or less, and in other embodiments, 10×10 or less. In one or more embodiments, porous layers have a mesh count of 10×10 or more, in other embodiments, 20×20 or more, in other embodiments, 30×30 or more, and in other embodiments, 40×40 or more. As with other quantitative disclosures herein, any of these mesh count end points may be utilized to form suitable ranges. In one or more embodiments, porous layers have a mesh count of about 10×10, in other embodiments, about 20×20, in other embodiments, about 30×30, and in other embodiments, about 40×40.

The values disclosed here and elsewhere herein should be appreciated as being arithmetic means, except where otherwise disclosed, in general accord with the understanding of the skilled person.

In one or more embodiments, the pore sizes of the pores of the porous layers are constant or substantially constant across each respective porous layers. That is, a first porous layer may have pores of a first substantially constant size, and a second porous layer may have pores of a second substantially constant size.

In other embodiments, the pore sizes of the pores of the porous layers may differ across respective porous layers. That is, a first porous layer may have pores of different sizes, and a second porous layer may have pores of other different sizes.

A gap, which may also be referred to as gap distance, should exist between respective electrodes (e.g. first porous layer and second porous layer). In one or more embodiments, a first gap exists between first porous layer and second porous layer and a second gap exists between second porous layer and third porous layer.

In one or more embodiments, an EWC device utilizing organic process fluids can have respective one or more gap distances ranging from about 0.25 mm to about 5 mm, in other embodiments, from about 0.4 mm to about 2.0 mm, in other embodiments, from about 0.5 mm to about 1.5 mm, and in other embodiments, from about 0.5 mm to about 1 mm. In one or more embodiments, the respective one or more gap distances are about 0.5 mm, in other embodiments, about 1 mm, in other embodiments, about 1.25 mm, and in other embodiments, about 1.5 mm.

In one or more embodiments, the wire and/or the porous layers may be coated, which may include a partial and/or a complete coating. In one or more embodiments, all internal components are coated. That is, everything inside a housing along the fluid flow path may be coated in one or more embodiments. In one or more embodiments, a coating is applied after wires are connected (e.g., welded).

In one or more embodiments, the coating can include a dielectric coating, a hydrophobic coating, and combinations thereof. In one or more embodiments, the coating can be a single coating having both a dielectric function and a hydrophobic function. In other embodiments, separate coatings serve the respective functions. The coating can generally serve to prevent possible short circuiting and provide an initial large drop contact angle. The dielectric coating may be referred to as an insulating dielectric coating.

In one or more embodiments, the coating includes first applying a layer of the insulating dielectric coating and then applying a layer of hydrophobic coating on the insulating dielectric coating. Exemplary insulating dielectric coatings include insulating dielectric polymers, such as poly(methyl methacrylate) (PMMA) and poly(styrene-co-methyl methacrylate) (PS/PMMA). An exemplary hydrophobic coating is a fluoropolymer-based film. An exemplary fluoropolymer-based film derives from commercially available material under the trade name FluoroPel (e.g., FluoroPel 1601V). These materials are generally known to the skilled person and include a fluoropolymer solution in a fluorosolvent. These materials can vary based on the amount of fluoropolymer, boiling point, and surface area, which can be selected for a desired design.

As suggested above, in one or more embodiments, the coating can be a polymer serving both a dielectric function and a hydrophobic function.

In view of a finding that coating mesh with certain coatings (e.g., PS/PMMA) can be problematic using the dip-coating method described in the '167 Pub. mentioned in the Background (i.e., mesh with pore openings smaller than 1 mm was generally found to have a tendency to plug under this method), in order to apply coatings without plugging or with minimal plugging, and still achieve sufficient coating to prevent short circuiting, a spray coating method may be utilized. Other techniques for applying the coating are also suitable.

The coating may be characterized by the thickness thereof. The thickness of a coating may be from a few nanometers all the way up to the gap distance. In one or more embodiments, a coating of a first porous layer may contact a coating of a second porous layer. In one or more embodiments, a coating may have a thickness of from about 2 nm to about 2 mm, in other embodiments, from about 0.2 μm to about 1 mm, and in other embodiments, from about 0.5 mm to about 1 mm. In one or more embodiments, a coating may have a thickness of from about 2 nm to about 50 nm, in other embodiments, from about 0.2 μm to about 10 μm, and in other embodiments, from about 0.5 mm to about 2 mm. The coating thickness should generally not be too thick as to plug the pores, though a relatively thicker coating could be used in connection with a relatively larger pore size.

Suitable coatings and thicknesses thereof may be further understood relative to analyzing the effectiveness of the coating. This may include performing a conductivity test, which can measure the effectiveness of the coating at preventing leakage of current and therefore reducing the potential of short circuit. An exemplary test includes dipping a coated porous layer and a steel wire in 5% NaCl solution, and connecting each to a respective end of a circuit to make a complete circuit. The current flowing through the circuit can then be measured (e.g., source measurement instrument Keithley 2400 Source Meter). An effective coating should have relatively minimal current passing through the coated porous layer (e.g., less than 2 micro Amps).

Further details of the fluid are now provided. As discussed elsewhere herein, the electrowetting coalescing device of the present disclosure coalesces droplets from a fluid. In one or more embodiments, the fluid includes a dispersed phase within a continuous phase. In one or more embodiments, the fluid is an organic process fluid with a dispersed phase and a continuous phase. As generally known to the skilled person, the term organic generally refers to any chemical compound that contains carbon-hydrogen bonds.

In one or more embodiments, the continuous phase can be an organic fluid loaded with metal, which may be referred to as a metal loaded organic fluid. As generally known to the skilled person, metal loaded organic fluids can derive from a metal recovery operation known as an extraction step. In these operations, an extractant (e.g., an organic in a diluent) may be used to extract one or more metals from an aqueous solution via ion exchange phenomena at the contact surface when the two phases come into contact. The extraction step produces a loaded organic fluid containing the metal of value and an aqueous phase depleted of the metal. The extraction or metal loading within a metal loaded organic fluid can generally depend on extraction efficiency, distribution ratio, separation factor, molarity, and mass transfer. The amount of metal within a metal loaded organic fluid may impact the amount of dispersed fluid (e.g., aqueous) in the continuous fluid (e.g., organic) and hence may lead to utilizing a certain number of stages for a plurality of the EWC devices.

In one or more embodiments, the dispersed phase includes aqueous droplets which optionally include further metal ions or acid salts, which may be referred to as a conductive aqueous fluid.

The organic process fluid, and the dispersed phase and the continuous phase thereof, may be characterized relative to conductivity. Generally speaking, the dispersed phase can be conductive or non-conductive, and the continuous phase should have a low conductivity.

In one or more embodiments, the dispersed phase has a conductivity of less than 1 μS/cm, in other embodiments, less than 10 μS/cm, and in other embodiments, less than 100 μS/cm. In one or more embodiments, the dispersed phase has a conductivity of from about 1 μS/cm to about 150,000 μS/cm, in other embodiments, from about 100 μS/cm to about 100,000 μS/cm, in other embodiments, from about 50,000 μS/cm to about 100,000 μS/cm, and in other embodiments, from about 60,000 μS/cm to about 80,000 μS/cm. In one or more embodiments, the dispersed phase has a conductivity of from about 75,000 μS/cm to about 150,000 μS/cm, and in other embodiments, from about 100,000 μS/cm to about 150,000 μS/cm.

In one or more embodiments, the continuous phase has a conductivity of less than 1 μS/cm, in other embodiments, less than 10 μS/cm, and in other embodiments, less than 100 μS/cm. In one or more embodiments, the continuous phase has a conductivity of from about 1 μS/cm to about 100 μS/cm, in other embodiments, from about 10 μS/cm to about 100 μS/cm, in other embodiments, from about 10 μS/cm to about 50 μS/cm, and in other embodiments, from about 50 μS/cm to about 100 μS/cm. In one or more embodiments, the continuous phase has a conductivity of from about 1 μS/cm to about 50 μS/cm, and in other embodiments, from about 1 μS/cm to about 50 μS/cm.

In view of these disclosed suitable numerical conductivities, the conductivities of the dispersed phase and the continuous phase may also be characterized relative to each other for one or more embodiments.

In one or more embodiments, the dispersed phase may have a different conductivity than the continuous phase. In one or more embodiments, the dispersed phase is 1 order of magnitude, in other embodiments, 2 orders of magnitude, in other embodiments, 3 orders of magnitude, in other embodiments, 4 orders of magnitude, and in other embodiments, 5 orders of magnitude, different in conductivity than the continuous phase.

In one or more embodiments, the dispersed phase may be more conductive than the continuous phase. In one or more embodiments, the dispersed phase is 1 order of magnitude, in other embodiments, 2 orders of magnitude, in other embodiments, 3 orders of magnitude, in other embodiments, 4 orders of magnitude, and in other embodiments, 5 orders of magnitude, more conductive than the continuous phase.

As suggested above, the organic process fluid can include ions. These ions can include a variety of ions, and can be in either or both of the dispersed phase and the continuous phase. Exemplary ions include generally the left two-thirds of the periodic table, ranging from Li to Po and including the Lanthanum series elements and the Actinium series elements. The ions may be formed from one or more of monovalent metal elements, divalent metal elements, and multivalent metal elements. Exemplary monovalent metal elements include Li, Na, K, and Rb. Exemplary divalent metal elements include Be, Mg, and Ca. And as generally known to the skilled person, transition metals (e.g., Ni, Cu, Zn, and Pd) can be in stable forms of several valence states.

In one or more embodiments, the organic process fluid is from industrial organic chemical products and processing (e.g., synthetic, coal, bio-, and petroleum chemicals), mining and extraction processing (e.g., minerals, metals, coal, gas, oil), petroleum refining, products, and processes, hydrometallurgy and solvent extraction processing, battery material processing, battery recycling processing (e.g., lithium ion battery waste, lithium ion battery production scrap, lithium ion cell production scrap, lithium ion cathode active material), and/or combinations thereof. In one or more embodiments, the organic process fluid is a nickel loaded petroleum distillate, a copper/nickel loaded petroleum distillate, a lithium loaded petroleum distillates, and/or combinations thereof.

In one or more embodiments, the organic process fluid is conductive or non-conductive with entrained aqueous droplets. In one or more embodiments, the organic process fluid may include charged particles or ions contained in the fluid, e.g., metal ions and/or salt ions. In one or more embodiments, metal ions and/or salt ions are within the continuous phase. In one or more embodiments, metal ions and/or salt ions are within the entrained aqueous droplets. In one or more embodiments, the organic process fluid may be a solution that contains one or more of extractants, modifiers, and solubilized metals/minerals.

The organic process fluid may be characterized based on polarity. In one or more embodiments, the organic process fluid includes a continuous phase, which may be a relatively non-polar liquid, and a dispersed phase, which may be a relatively polar liquid. To the extent the term polarity is used herein, the polarities of the continuous phase and the dispersed phase should be considered relative to each other. That is, the polarity (and other intermolecular forces) of the continuous phase and the dispersed phase should be such that the dispersed phase exists as a dispersion within the continuous phase. This may be referred to as the dispersed phase being relatively more polar that the continuous phase. This may also be referred to as the organic process fluid including a polar solution (i.e., dispersed phase) and a far less polar solution (i.e., continuous phase). It may be desirable for the organic process fluid to be devoid of or substantially devoid of components (e.g., modifiers) that would otherwise make the interfaces relatively polar. The dispersed phase should be generally immiscible with the continuous phase, and if the relative polarities are identical or too similar, the dispersed phase will not be immiscible in the continuous phase. Exemplary relatively polar liquids include water, wastewater from different processing steps, and/or production, such as lithium-ion battery waste. Exemplary relatively non-polar or slightly polar liquids include hydrocarbons. In one or more embodiments, exemplary hydrocarbons include petroleum distillates and dearomatized hydrocarbons.

In one or more embodiments, the continuous phase includes metal salts (i.e., metal ions), complexes of metals, metal chelates, and/or combinations thereof. The continuous phase may be referred to as an organic phase loaded with metal. In one or more embodiments, the continuous phase generally does not include free ions. In one or more embodiments, the continuous phase includes one or more of carboxylic acids, amines, aldehydes, and ketones.

In one or more embodiments, the dispersed phase includes one or more of acid salts, metal salts, alcohols, and aqueous solutions.

The organic process fluid may be characterized relative to the amount of the dispersed phase within the continuous phase. A variety of suitable amounts of dispersed phase within the continuous phase may be utilized, including relatively lower amounts of the dispersed phase and relatively higher amounts of the dispersed phase.

In one or more embodiments, the amount of the dispersed phase, which may also be referred to as concentration, within the continuous phase may be from about 0.01 vol. % to about 3 vol. %, in other embodiments, from about 0.1 vol. % to about 2 vol. %, in other embodiments, from about 0.5 vol. % to about 1.5 vol. %, and in other embodiments, from about 0.6 vol. % to about 1 vol. %. In one or more embodiments, the amount of the dispersed phase within the continuous phase may be less than 3 vol. %, in other embodiments, less than 2 vol. %, in other embodiments, less than 1.5 vol. %, in other embodiments, less than 1 vol. %, in other embodiments, less than 0.6 vol. %, and in other embodiments, less than 0.5 vol. %.

In one or more embodiments, the amount of the dispersed phase within the continuous phase may be from about 0.01 wt. % to about 1.5 wt. %, in other embodiments, from about 0.1 wt. % to about 1.2 wt. %, in other embodiments, from about 0.3 wt. % to about 1 wt. %, and in other embodiments, from about 0.5 wt. % to about 1 wt. %. In one or more embodiments, the amount of the dispersed phase within the continuous phase may be less than 1.5 wt. %, in other embodiments, less than 1.2 wt. %, in other embodiments, less than 1 wt. %, in other embodiments, less than 0.6 wt. %, in other embodiments, less than 0.5 wt. %, and in other embodiments, less than 0.3 wt. %.

The skilled person will understand concentration and conductivity can be related, and therefore these disclosed concentrations and the conductivities disclosed herein may be utilized in an interrelated manner.

Further details of suitable process conditions for the EWC are now provided.

The electrowetting coalescence device may be characterized by flow rate passing through the electrowetting coalescence device. The flow rate may affect, for example, droplet capture and/or droplet break-up. Suitable flow rates are provided herein in the context of face velocity. As generally known to the skilled person, the face velocity refers to flow rate divided by area of a porous layer, such that the below quantified face velocities can be used in conjunction with a desired area of a porous layer in order to calculate flow rates. That is, for a given flow, face velocity may be reduced by making the area larger. If the face velocity is too high, small drops may not be suitably captured and large drops may break into small drops.

In one or more embodiments, face velocity through an electrowetting coalescence device ranges from about 0.1 cm/min or more to 2,000 cm/min or less, in one or more embodiments, from about 0.1 cm/min or more to 1,000 cm/min or less, in one or more embodiments, from about 0.1 cm/min or more to 400 cm/min or less, in one or more embodiments, from about 0.1 cm/min or more to 300 cm/min or less, in one or more embodiments, from about 0.1 cm/min or more to 200 cm/min or less. In one or more embodiments, face velocity through an electrowetting coalescence device ranges from about 0.1 cm/min or more to 40 cm/min or less, in one or more embodiments, from about 0.1 cm/min or more to 30 cm/min or less, in one or more embodiments, from about 0.1 cm/min or more to 20 cm/min or less, in one or more embodiments, from about 0.1 cm/min or more to 10 cm/min or less, in one or more embodiments, from about 1 cm/min or more to 10 cm/min or less, in one or more embodiments, from about 2 cm/min or more to 8 cm/min or less, in one or more embodiments, from about 4 cm/min or more to 6 cm/min or less, and in one or more embodiments, from about 1 cm/min or more to about 3 cm/min or less. In one or more embodiments, face velocity through an electrowetting coalescence device may be about 1 cm/min, in one or more embodiments, about 4 cm/min, in one or more embodiments, about 5 cm/min, in one or more embodiments, about 6 cm/min, in one or more embodiments, about 10 cm/min, in one or more embodiments, about 15 cm/min, in one or more embodiments, about 20 cm/min, and in one or more embodiments, about 30 cm/min.

As discussed above, the electrodes described herein are used to create a voltage difference, e.g., between a first electrode and a second electrode, and in one or more embodiments, between a second electrode and a third electrode, and so on, to thereby generate one or more electric fields in an electrowetting coalescence device. In one or more embodiments, the applied voltage provided to a positive electrode may range from about 1 V to about 800 V, in other embodiments, from about 1 V to about 700 V, in other embodiments, from about 1 V to about 500 V, in other embodiments, from about 1 V to about 450 V. In one or more embodiments, the applied voltage provided to a positive electrode may range from about 50 V to about 800 V, in other embodiments, from about 50 V to about 500 V, in other embodiments, from about 100 V to about 800 V, in other embodiments, from about 100 V to about 300 V, in other embodiments, from about 300 V to about 500 V, in other embodiments, from about 150 V to about 500 V, in other embodiments, from about 200 V to about 250 V, and in other embodiments, from about 210 V to about 230 V. In one or more embodiments, the applied voltage provided to a positive electrode may be about 100 V, in other embodiments, about 150 V, in other embodiments, about 200 V, in other embodiments, about 210 V, in other embodiments, about 300 V, and in other embodiments, about 500 V, and in other embodiments, about 700 V.

The voltage differences and gap distances disclosed herein can be used to develop suitable electric fields. That is, electric field strength can be referred to as the voltage difference divided by the gap distance. The values disclosed herein for voltage differences and gap distances can therefore also be used for values of the electric field.

The temperature of the fluid and the components of the EWC during operation should be about the same. In one or more embodiments, the temperature of the fluid and the components of the EWC during operation ranges from about room temperature (i.e., 20° C. to 22° C. or 68° F. to 72° F.) to about 60° C. (140° F.). In one or more embodiments, the temperature of the fluid and the components of the EWC during operation is about room temperature. In one or more embodiments, the temperature of the fluid and the components of the EWC during operation is about 50° C. (120° F.). In one or more embodiments, the temperature of the fluid and the components of the EWC during operation is in a range of from about 0° C. (32° F.) to about 80° C. (176° F.). In one or more embodiments, these disclosed ranges may also be down to about −20° C. (−4° F.). The temperature can generally be any suitable temperature at which the fluid passing through the EWC will be in liquid form. That is, the temperature of the environment where the EWC is being used and/or applied can be in a range of above the crystallization point and below the boiling point of the fluid passing through the EWC. The liquid fluid should not go through a phase change during operation of the EWC.

The EWC can be characterized by separation efficiency, which generally is a measure of the effectiveness of the EWC to coalesce smaller drops into collected drops. Separation efficiency can be calculated by

$$Efficiency = \frac{{c}_{inlet} - {c}_{outlet}}{{c}_{inlet}} \times 100 \% \qquad Equation ( 1 )$$

where Cᵢₙₗₑₜ is the inlet concentration of the dispersed phase and Cₒᵤₜₗₑₜ is the concentration of the dispersed phase in the fluid exiting the EWC. This definition in Equation (1) for the separation efficiency assumes the EWC operates in series with a separation device that removes the enlarged collected drops. The inlet concentration, Cᵢₙₗₑₜ, is the concentration of the dispersed phase entering the EWC while the outlet concentration, Cₒᵤₜₗₑₜ, is the concentration of the dispersed phase exiting the separator. That is, the EWC will convert some of the fine drops of the dispersed phase into coarse drops, such that the stream entering the separator will include both fine drops and coarse drops. Most of the coarse drops will then be separated out in the separator, and the outlet concentration, Cₒᵤₜₗₑₜ, is based on the stream from which the coarse drops have been separated, which stream will include mostly fine drops of the dispersed phase.

The EWC can have any suitable separation efficiency. In one or more embodiments, the EWC has a separation efficiency of from about 40% to about 95%, in other embodiments, from about 50% to about 90%, in other embodiments, from about 60% to about 90%, and in other embodiments, from about 80% to about 90%. In one or more embodiments, the EWC has a separation efficiency of from about 60% to about 80%, in other embodiments, from about 70% to about 80%, and in other embodiments, from about 60% to about 70%. In one or more embodiments, the EWC has a separation efficiency of at least 60%, in other embodiments, at least 70%, in other embodiments, at least 80%, and in other embodiments, at least 90%.

The EWC can be operated either in single pass operation or multi-pass operation. Single pass operation generally refers to the fluid passing through the EWC one time. Multi-pass operation generally refers to the fluid passing through the EWC multiple times, which may also be referred to as recycle.

The EWC should collect and load up with water for sufficient effectiveness of coalescing the drops. If the EWC is low with water saturation (i.e., loading of water), such as in certain initial scenarios, many of the fine drops will not coalesce, and the resulting separation efficiency would be low. To increase the separation efficiency the EWC may be pre wetted and/or should operate for a long enough time to load with enough water. The single pass operation may be particularly utilized when there is a very large volume of fluid as a source (e.g., in a source tank). This will would generally be a continuous flow operation.

In one or more embodiments, in steady state operation, the first part of the fluid to pass through the EWC may be recycled back through the EWC once operating at higher efficiency to separate the dispersed phase that was not separated initially.

When the volume of source fluid is relatively small, all of the source fluid may pass through the EWC before steady state is reached. The net result is the separation efficiency would be low. In this case, it may be better to operate the EWC in multi-pass operation in order to recycle the fluid multiple times until the saturation has increased to the level with higher separation efficiency.

As suggested above, in one or more embodiments, the electrowetting coalescence device may be prewet prior to process operation. That is, it is desirable for the EWC to reach steady state performance (i.e., full saturation) at an early point of the process operation. Prewetting may be referred to as causing the EWC to reach full saturation in a manner additional to processing the organic process fluid. Prewetting may be utilized to reach steady state performance more quickly, where desired. In one or more embodiments, prewetting can be achieved by adding water upstream of the EWC, which water will subsequently reach the EWC, prior to process operation to thereby saturate the EWC with the water. The water for prewetting may be added to the organic process fluid. This may be prior to any organic process fluid reaching the EWC, or in other embodiments, after an initial amount of the organic process fluid has passed to the EWC. Said another way, the organic process fluid can be provided in an upstream vessel and then extra water combined therewith, such that the water, being denser than the organic process fluid, settles below the organic process fluid and is therefore pumped to the EWC. Then the rest of the organic process fluid can be subsequently provided to the EWC. Any non-saturating water can be collected as part of the collection techniques disclosed herein.

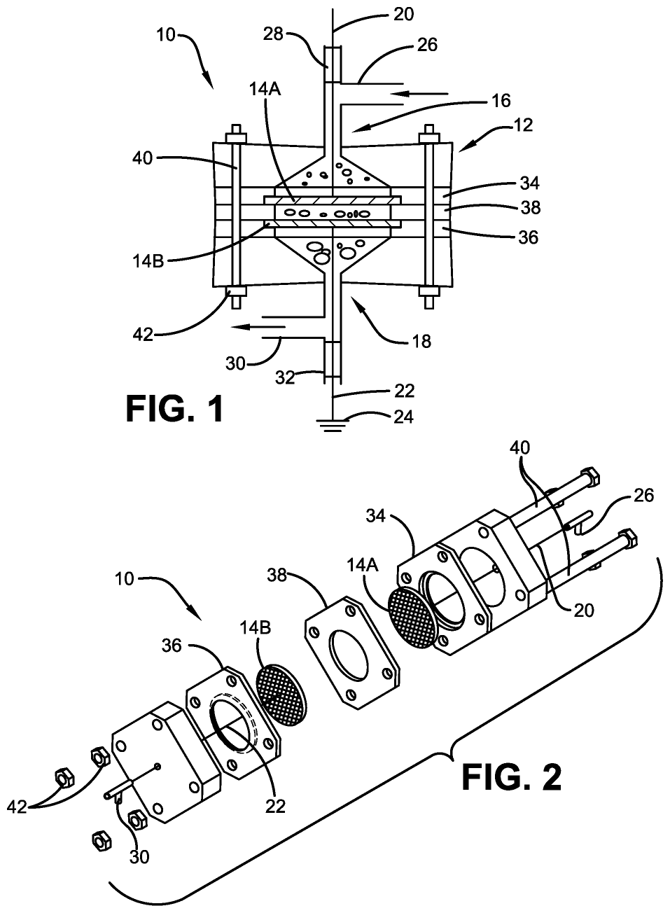

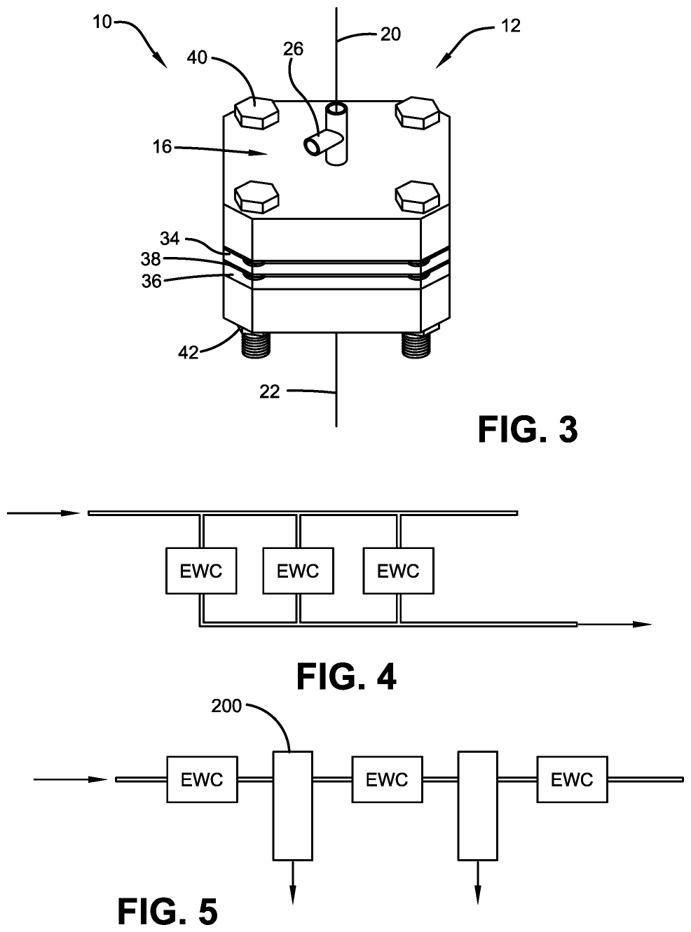

With particular reference to FIGS. 1 to 3, one or more embodiments of the present invention provide an EWC device 10, which may also be referred to as an EWC assembly 10, an EWC 10, or a device 10. EWC device 10 includes a housing 12 which includes the porous layers. Porous layer 14A is the inlet porous layer, which may also be referred to as a porous first electrode 14A, and porous layer 14B is the outlet porous layer, which may also be referred to as a porous second electrode 14B. A suitable electric field exists between porous first electrode 14A and porous second electrode 14B.

Housing 12 includes an inlet 16 and an outlet 18 with porous layers 14A, 14B positioned therebetween. The inlet 16 can include a cone shaped passage and the outlet can includes a cone shaped passage which may generally assist with spreading the flow across the whole porous layers 14A, 14B and also may generally avoid a jet of flow from the inlet 16 through centers of the porous layers 14A, 14B. The inlet 16 and outlet 16 sections may be referred to as relatively thicker (i.e., thicker than porous layers 14A, 14B) rectangular shapes which include a flow region, which may be a conical flow region. In one or more embodiments, inlet 16 and outlet 16 sections may be of similar or identical shape, though flipped upside down relative to the other.

EWC device 10 can receive an organic process fluid, the organic process fluid including a dispersed phase within a continuous phase. The organic process fluid will pass through the inlet 16, the porous first electrode 14A, the electric field, the porous second electrode 14B, and the outlet 18. In doing so, the electrowetting coalescing device 10 will thereby coalesce smaller droplets of the dispersed phase into larger droplets of the dispersed phase for subsequent removal of the larger droplets from the continuous phase.

The porous first electrode 14A includes a first independent electrical connection thereto, which in FIGS. 1 to 3 is shown as a wire 20. Similarly, the porous second electrode 14B includes a second independent electrical connection thereto, shown as a wire 22. In FIGS. 1 to 3, wire 22 is grounded at ground 24. A voltage is applied and maintained through wire 20 to the porous first electrode 14A, thereby creating the electric field between the porous first electrode 14A and the porous second electrode 14B. As such, EWC 10 can operate according to the disclosure herein.

As shown in FIGS. 1 to 3, inlet 16 can include a T fitting 26 with the wire 20 passing through one leg of the T fitting 26. The wire 20 extends perpendicular from porous first electrode 14A through the T fitting 26. T fitting 26 includes a sleeve 28 to prevent leakage of liquid. The wire 20 should be insulated, which can include application of the coating described elsewhere herein. In accord with the disclosure elsewhere herein, all components of EWC 10 (e.g., porous electrodes 14A, 14B) can also include the coating.

Suitable materials for sleeve 28, which may also be referred to as a compression fitting 28 or an adapter 28, include polytetrafluoroethylene (Teflon™) and heat shrink tubing, which heat shrink tubing may be made of a polyolefin as a crosslinked crystalline polymer.

Similar to inlet 16, outlet 18 is also shown with a T fitting 30 with the wire 22 passing through one leg of the T fitting 30. T fitting 26 includes a sleeve 32, which is similar to sleeve 28.

As further description of wires 20, 22, the wires may be soldered to the respective electrodes 14A, 14B. In one or more embodiments, the wire is connected with the center of the electrodes. Other exemplary connection techniques include welding and brazing. The wires or other electrical contacts should be provided to each electrode without causing short circuiting from contacting the walls of EWC 10.

As further description of housing 12, FIGS. 1 to 3 shows porous first electrode 14A within a first outer frame 34 and porous second electrode 14B within a second outer frame 36. Between first outer frame 34 and second outer frame 36 is a spacer 38. First outer frame 34, second outer frame 36, and spacer 38 are secured in place with threaded rods 40 secured in place with fasteners 42 at each end.

First outer frame 34 and second outer frame 36 each include a respective cutout for holding a respective porous electrode 14A, 14B. That is, porous electrode 14A is positioned in the cutout of first outer frame 34 and is positioned between the cutout lip and the spacer 38, and porous electrode 14B is positioned in the cutout of second outer frame 36 and is positioned between the cutout lip and the other side of spacer 38. Spacer 38 extends straight across the housing 12 and can be a straight piece except for the center hole between the porous electrodes 14A, 14B (i.e., does not include a cutout). In one or more embodiments, porous electrode 14A and porous electrode 14B may be of similar or identical shape, though flipped upside down relative to the other.

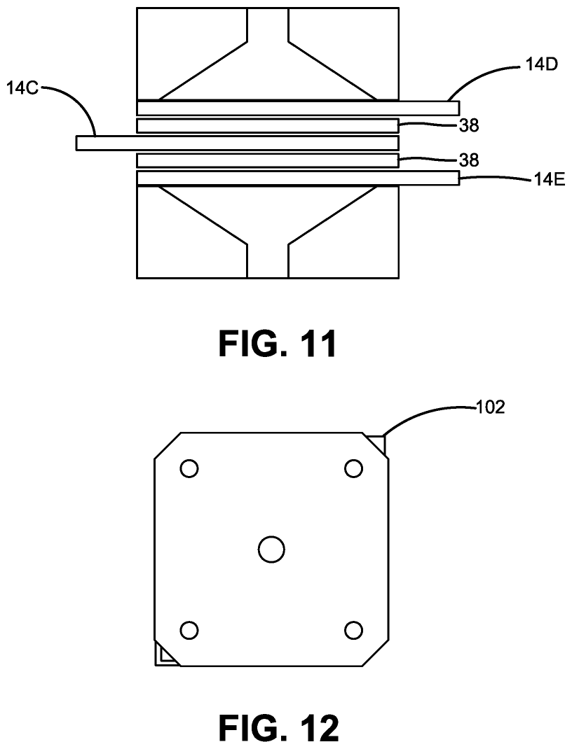

With particular reference to FIGS. 9 to 12, one or more embodiments of the present invention provide EWC device 100, which may also be referred to as an EWC assembly 100, an EWC 100, or a device 100. EWC device 100 is similar to EWC 10 except as described here.

EWC device 100 include a third porous electrode 14C positioned between a top porous electrode 14D and a bottom porous electrode 14E. The function of the porous electrodes is otherwise similar to as disclosed above. EWC device 100 having three electrodes 14C, 14D, 14E generally operates similar to two EWC devices 10 being in series without an intermediate separator.

With the presence of the middle third porous electrode 14C, it could be problematic to connect a wire to third porous electrode 14C. EWC device 100 therefore includes porous electrodes 14C, 14D, 14E with respective tabs 102 (FIG. 10) protruding from the housing 104, which housing can be generally similar to housing 12. Tabs 102 therefore provide the mechanism for applying independent electrical connections to porous electrodes 14C, 14D, 14E. Tabs 102 may be unitary with porous electrodes 14C, 14D, 14E such as by cutting sheets in a shape which allows the tab 102 as a small piece of the metal to stick out of the housing 104, as particularly shown in FIG. 10.

As shown in FIGS. 9 and 10, tabs 102 can extend generally from a side of porous electrodes 14C, 14D, 14E. In other embodiments, as shown in FIG. 12, tabs 102 can extend generally from a corner of porous electrodes 14C, 14D, 14E.

In one or more embodiments, the outer electrodes 14D, 14E have independent applied and maintained voltages and the middle electrode 14C is ground at 0 V. In other embodiments, the middle electrode 14C has an applied and maintained voltage and the outer electrodes 14D, 14E are ground at 0 V (e.g., FIG. 7).

In one or more embodiments, the outer electrodes 14D, 14E can include wired connections as disclosed relative to EWC 10.

In one or more embodiments, where the electrodes (e.g., 14D, 14E) are not sized to match the housing (e.g., housing 104), a sealant such as epoxy can be used to plug the pores where flow is undesired.

One or more embodiments of the present invention relate to utilizing a plurality of the EWC devices (e.g., EWC 10). In one or more embodiments, with reference to FIG. 4, a plurality of the EWC devices may be used by manifolding multiple EWCs (e.g., EWC 10), which will generally serve to increase area and reduce face velocity.

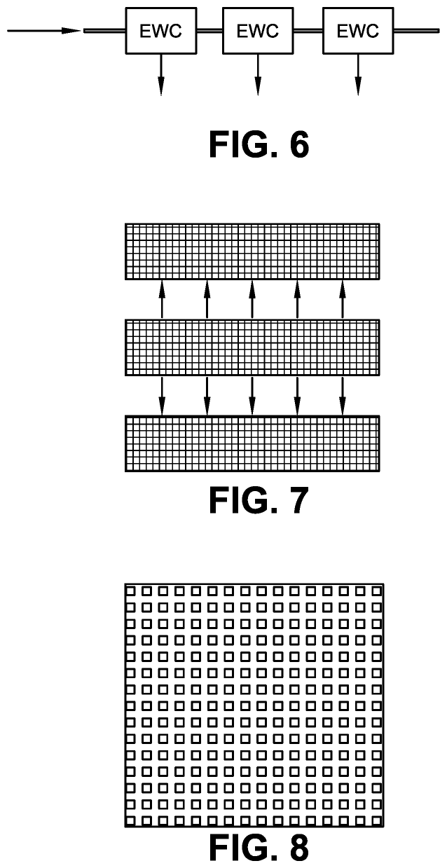

In one or more embodiments, a plurality of the EWC devices may be used by employing successive EWCs, which will generally serve to allow higher face velocities. In one or more embodiments, with reference to FIG. 5, a plurality of the EWC devices may be used by employing successive EWCs with a separator 200 between each two EWCs. In one or more embodiments, with reference to FIG. 6, a plurality of the EWC devices may be used by employing successive EWCs without a separator between each two EWCs.

One or more embodiments of the present invention relate to a mechanistic model for the operation and/or design of an EWC. The model utilizes the term E as the capture efficiency of the electrowetting coalescing device, which represents an effectiveness at which the smaller droplets are converted into the larger droplets for collection thereof. The model also utilizes the term R as a release coefficient, which represents an ability of the larger droplets to release from the electrowetting coalescing device. The model also utilizes S as a water saturation content, and a, E_{O}, b, and n as fitted parameters.

The model is based on a balance of water accumulated in the EWC. Saturation S is defined as the volume of water in the EWC divided by the volume of the EWC. The concentrations of fine (small) and coarse (enlarged) drops entering the EWC are ƒₒ and cₒ. The fine and course concentrations exiting the EWC are ƒ and c. The total water concentration C in Equation (1) (above) in a given stream is related to the fine and coarse concentrations by C=ƒ+c.

A water mass balance on the EWC gives the time dependent differential equation, Equation 3, of

$$\frac{dS}{dt} = ( {c}_{o} + {f}_{o} E ) \frac{Q}{ρ V} - \frac{RQ}{V} \qquad Equation ( 3 )$$

where E is the capture efficiency of the EWC to capture and coalesce the fine drops, R is the release coefficient, Q is the volumetric flow rate, V is the volume of the EWC, and ρ is the mass density of the dispersed fluid. If the separation device (with reference to the above discussion relative to Equation (1)) is 100% effective at removing the coarse drops, then the instantaneous separation efficiency in Equation (1) is the same as the capture efficiency, E. The fine and coarse drop concentrations are related to the capture efficiency by Equations (4) and (5):

$$f = {f}_{o} - {f}_{o} E \qquad Equation ( 4 )$$

$$c = {c}_{o} + {f}_{o} E . \qquad Equation ( 5 )$$

This model to this point has 3 equations (Equation 3, Equation 4, Equation 5) but 5 unknowns (S, ƒ, c, E, R). To obtain mathematical closure, two more equations are needed.

Evaluation of experimental data showed the capture efficiency is linearly dependent upon the water content (saturation, S) in the EWC while the release coefficient R is dependent in a power-law form, according to the below Equation (6) and Equation (7):

$$E = a S + {E}_{o} \qquad Equation ( 6 )$$

$$R = b {S}^{n} . \qquad Equation ( 7 )$$

In some applications the inlet concentration of the coarse drops may be zero, c₀=0 but in general the fines inlet concentration ƒₒ is not zero. The model Equations (3) through (7) may be modified or expanded to include operations with separating devices to account for the effectiveness of the separator. The model may also be expanded to account for the volume of the source fluid and can be applied to single pass or multi-pass operations, and can be applied to EWCs in series or in parallel with or without separators.

It was initially expected that a, E_{O}, b, and n were to be functions of the operation (e.g., flow rate, temperature, voltage, and fluid type) and the EWC design (e.g., pore size and gap size). However, analysis shows E_{O} and n vary over a small range and may be considered constants for purposes of operation and design of the EWC. More specifically, E_{O} is 0.30+/−0.05 and n=2.9+/−0.4. Though E_{O} and n are generally dependent on flow (i.e., face velocity) for any given EWC device. Use of the model will additionally include determining a and b by empirically fitting different flow rates of a given organic process fluid with the mechanistic model. Once a and b are found, Equations (3) through (7) become a closed set of equations and can be used for assisting with designing an EWC device for a desired flow rate.

### Embodiments

Without limitation, embodiments of the disclosure include:

Embodiment 1. An electrowetting coalescing device for coalescing droplets of a dispersed phase within a continuous phase of an organic process fluid, the electrowetting coalescing device comprising an inlet; a porous first electrode with a first independent electrical connection thereto, the porous first electrode including a first plurality of pores having a first average pore size; a porous second electrode with a second independent electrical connection thereto, the porous second electrode including a second plurality of pores having a second average pore size, where the second average pore size is different from the first average pore size; a voltage applied and maintained to the porous first electrode, where the porous second electrode is at a second voltage different from the voltage applied and maintained to the porous first electrode, where the second voltage is optionally a 0 V ground, thereby creating an electric field between the porous first electrode and the porous second electrode; an outlet; and the organic process fluid, the organic process fluid including the dispersed phase within the continuous phase, the continuous phase including an organic fluid loaded with metal, and the dispersed phase including aqueous droplets which optionally include further metal ions or acid salts, the dispersed phase being conductive or non-conductive, the continuous phase having a low conductivity; the electrowetting coalescing device receiving the organic process fluid, the organic process fluid passing through the inlet, the porous first electrode, the electric field, the porous second electrode, and the outlet, the electrowetting coalescing device thereby coalescing smaller droplets of the dispersed phase into larger droplets of the dispersed phase for subsequent removal of the larger droplets from the continuous phase.

Embodiment 2. The device of embodiment 1, where the first independent electrical connection provides an applied and maintained voltage of about 50 V to about 500 V to the porous first electrode, and where the second independent electrical connection is a connection to a ground such that the porous second electrode has 0 V.

Embodiment 3. The device of embodiment 1, further comprising a porous third electrode, the porous third electrode positioned as a middle electrode between the porous first electrode and the porous second electrode, the porous third electrode having a third independent electrical connection thereto, the porous third electrode being at a third voltage different from the voltage applied and maintained to the porous first electrode and different from the second voltage.

Embodiment 4. The device of embodiment 3, where the porous first electrode and the porous second electrode have 0 V, and where the third independent electrical connection provides an applied and maintained voltage of about 50 V to about 500 V to the porous third electrode.

Embodiment 5. The device of embodiment 3, where the first independent electrical connection provides an applied and maintained voltage of about 50 V to about 500 V to the porous first electrode and the second independent electrical connection provides an applied and maintained voltage of about 50 V to about 500 V to the porous second electrode, and where the porous third electrode has 0 V.

Embodiment 6. The device of any of the above embodiments, where the porous first electrode, the porous second electrode, and the porous third electrode are wire mesh.

Embodiment 7. The device of any of embodiments 1 to 5, where the porous first electrode, the porous second electrode, and the porous third electrode are perforated plates.

Embodiment 8. The device of any of the above embodiments, the first average pore size being defined by a first plurality of pores having a substantially constant pore size.

Embodiment 9. The device of any of the above embodiments, the second average pore size being defined by a second plurality of pores having a substantially constant pore size.

Embodiment 10. The device of any of embodiments 1 to 7, the first average pore size being defined by a first plurality of pores having different pore sizes.

Embodiment 11. The device of any of embodiments 1 to 7, the second average pore size being defined by a second plurality of pores having different pore sizes.

Embodiment 12. The device of any of the above embodiments, where the first independent electrical connection comprises a first wire electrically connected to the porous first electrode and the second independent electrical connection comprises a second wire electrically connected to the porous second electrode.

Embodiment 13. The device of embodiment 12, where the first wire and the second wire are made of steel.

Embodiment 14. The device of any of the above embodiments, where the electrical connections are selected from soldering, welding, and brazing.

Embodiment 15. The device of any of the above embodiments, where the porous first electrode and the porous second electrode are each coated with a coating.

Embodiment 16. The device of any of the above embodiments, where the porous third electrode is coated with a coating.

Embodiment 17. The device of any of the above embodiments, where all internal components of the device, including the first independent electrical connection and the second independent electrical connection, are coated with a coating.

Embodiment 18. The device of any of embodiments 15 to 17, where the coating includes a dielectric coating layer and a hydrophobic coating layer on the dielectric coating layer.

Embodiment 19. The device of embodiment 18, where the dielectric coating layer includes poly(styrene-co-methyl methacrylate).

Embodiment 20. The device of embodiment 18, where the hydrophobic coating layer includes a fluoropolymer-based film.

Embodiment 21. The device of embodiment 20, where the fluoropolymer-based film derives from a fluoropolymer solution in a fluorosolvent.

Embodiment 22. The device of any of the above embodiments, where one or more of the porous first electrode, the porous second electrode, and the porous third electrode has a pore size ranging from about 0.1 millimeters to about 3 millimeters.

Embodiment 23. The device of any of the above embodiments, where a gap distance between respective ones of the porous first electrode, the porous second electrode, and the porous third electrode ranges from about 0.25 mm to about 5 mm.

Embodiment 24. The device of any of the above embodiments, where a gap distance between respective ones of the porous first electrode, the porous second electrode, and the porous third electrode ranges from about 0.5 mm to about 1 mm.

Embodiment 25. The device of any of the above embodiments, where one or more of the porous first electrode, the porous second electrode, and the porous third electrode are made of stainless steel.

Embodiment 26. The device of any of the above embodiments, where the first independent electrical connection includes a first insulated fitting and the second independent electrical connection includes a second insulated fitting to prevent loss or release of the organic process fluid.

Embodiment 27. The device of embodiment 26, where the first insulated fitting and the second insulated fitting are compression fittings, where the compression fittings comprise a respective polytetrafluoroethylene sleeve having a respective one of the first wire and the second wire passing therethrough.

Embodiment 28. The device of any of the above embodiments, where the organic process fluid is chosen from one or more of industrial organic chemical products; industrial organic chemical processing fluids; mining and extraction processing fluids; petroleum refining fluids; hydrometallurgy and solvent extraction processing fluids; battery material processing fluids; and battery recycling processing fluids.

Embodiment 29. The device of any of the above embodiments, where the organic process fluid is a metal loaded organic fluid.

Embodiment 30. The device of any of the above embodiments, where the dispersed phase is highly conductive.

Embodiment 31. The device of any of the above embodiments, where the continuous phase is a relatively non-polar liquid with respect to a polarity of the dispersed phase.

Embodiment 32. The device of embodiment 31, where the relatively non-polar liquid comprises one or more of metal ions and metal ion complexes.

Embodiment 33. The device of embodiment 31 or 32, where the relatively non-polar liquid comprises one or more of carboxylic acids, amines, aldehydes, ketones, and alcohols.

Embodiment 34. The device of any of the above embodiments, where the dispersed phase is a relatively polar liquid with respect to a polarity of the continuous phase, where the relatively polar liquid comprises one or more of water, alcohols, acid salts, and metal salts.

Embodiment 35. The device of any of the above embodiments, the dispersed phase having a conductivity of from about 1 μS/cm to about 150,000 μS/cm, the continuous phase having a conductivity of less than 100 μS/cm.

Embodiment 36. An assembly comprising a plurality of the devices of any of the above embodiments, where the plurality of the devices are in a manifolded configuration.

Embodiment 37. An assembly comprising a plurality of the devices of any of embodiments 1 to 35, where the plurality of the devices are in a successive configuration, with or without a separator between each two devices of the plurality of the devices.

Embodiment 38. The assembly of embodiment 37, where the separator is present between each of the two devices of the plurality of the devices.

Embodiment 39. A method for coalescing droplets of a dispersed phase within a continuous phase of an organic process fluid in an electrowetting coalescing device, the method including steps of providing the electrowetting coalescing device; providing the organic process fluid, the organic process fluid including the dispersed phase within the continuous phase, the continuous phase including an organic fluid loaded with metal, and the dispersed phase including aqueous droplets which optionally include further metal ions or acid salts, the dispersed phase being conductive or non-conductive, the continuous phase having a low conductivity; allowing the organic process fluid to flow through the electrowetting coalescing device; allowing the droplets of the dispersed phase to electrowet to form larger droplets; and removing the larger droplets from the continuous phase.

Embodiment 40. The method of embodiment 39, where the electrowetting coalescing device is part of an assembly.

Embodiment 41. The method of embodiment 39 or 40, where the organic process fluid is chosen from one or more of industrial organic chemical products; industrial organic chemical processing fluids; mining and extraction processing fluids; petroleum refining fluids; hydrometallurgy and solvent extraction processing fluids; battery material processing fluids; and battery recycling processing fluids.

Embodiment 42. The method of any of embodiments 39 to 41, where the organic process fluid is a metal loaded organic fluid.

Embodiment 43. The method of any of embodiments 39 to 42, where the dispersed phase is highly conductive.

Embodiment 44. The method of any of embodiments 39 to 43, where the continuous phase is a relatively non-polar liquid with respect to a polarity of the dispersed phase.

Embodiment 45. The method of embodiment 44, where the relatively non-polar liquid comprises one or more of metal ions and metal ion complexes.

Embodiment 46. The method of embodiment 44 or 45, where the relatively non-polar liquid comprises one or more of carboxylic acids, amines, aldehydes, ketones, and alcohols.

Embodiment 47. The method of any of embodiments 39 to 46, where the dispersed phase is a relatively polar liquid with respect to a polarity of the continuous phase, where the relatively polar liquid comprises one or more of water, alcohols, acid salts, and metal salts.

Embodiment 48. The method, assembly, or device of any of the above embodiments, where a mechanistic model is utilized for design or operation thereof, where the mechanistic model comprises:

$$\frac{dS}{dt} = ( {c}_{o} + {f}_{o} E ) \frac{Q}{ρ V} - \frac{RQ}{V} \qquad Equation ( 3 )$$

$$f = {f}_{o} - {f}_{o} E \qquad Equation ( 4 )$$

$$c = {c}_{o} + {f}_{o} E \qquad Equation ( 5 )$$

$$E = a S + {E}_{o} \qquad Equation ( 6 )$$

$$R = b {S}^{n} , \qquad Equation ( 7 )$$

where E is the capture efficiency of the electrowetting coalescing device and represents an effectiveness at which the smaller droplets are converted into the larger droplets for collection thereof, R is a release coefficient and represents an ability of the larger droplets to release from the electrowetting coalescing device, S is a water saturation content, and a, E_{O}, b, and n are fitted parameters; where Q is a volumetric flow rate through the EWC, V is a volume of the EWC, and ρ is a mass density of the dispersed phase; where concentrations of the smaller droplets and the larger droplets drops entering the EWC are ƒₒ and cₒ, and concentrations of the smaller droplets and the larger droplets drops exiting the EWC are ƒ and c.

Embodiment 49. The method of embodiment 48, where E_{O} is 0.30+/−0.05, and where n=2.9+/−0.4.

Embodiment 50. The method of embodiment 48 or 49, further comprising determining a and b based on empirically fitting different flow rates of the organic process fluid with the mechanistic model.

Embodiment 51. A method of designing an electrowetting coalescing device, the method including steps of providing an organic process fluid, the organic process fluid including a dispersed phase within a continuous phase, the continuous phase including an organic fluid loaded with metal, and the dispersed phase including aqueous droplets which optionally include further metal ions or acid salts; providing a mechanistic model, where the mechanistic model comprises:

$$\frac{dS}{dt} = ( {c}_{o} + {f}_{o} E ) \frac{Q}{ρ V} - \frac{RQ}{V} \qquad Equation ( 3 )$$

$$f = {f}_{o} - {f}_{o} E \qquad Equation ( 4 )$$

$$c = {c}_{o} + {f}_{o} E \qquad Equation ( 5 )$$

$$E = a S + {E}_{o} \qquad Equation ( 6 )$$

$$R = b {S}^{n} , \qquad Equation ( 7 )$$

where E is the capture efficiency of the electrowetting coalescing device and represents an effectiveness at which smaller droplets are converted into larger droplets for collection thereof, R is a release coefficient and represents an ability of the larger droplets to release from the electrowetting coalescing device, S is a water saturation content, and a, E_{O}, b, and n are fitted parameters; where Q is a volumetric flow rate through the EWC, V is a volume of the EWC, and ρ is a mass density of the dispersed phase; where concentrations of the smaller droplets and the larger droplets drops entering the EWC are ƒₒ and cₒ, and concentrations of the smaller droplets and the larger droplets drops exiting the EWC are ƒ and c; and manufacturing the desired electrowetting coalescing device based on the mechanistic model and properties of the predetermined organic process fluid.

Embodiment 52. The method of embodiment 51, where E_{O} is 0.30+/−0.05, and where n=2.9+/−0.4.

Embodiment 53. The method of embodiment 51 or 52, further comprising a step of determining a and b based on empirically fitting different flow rates of the organic process fluid with the mechanistic model.

Embodiment 54. The device of embodiment 4, where the third independent electrical connection provides an applied and maintained voltage of about 100 V to about 300 V to the porous third electrode.

Embodiment 55. The device of embodiment 5, where the first independent electrical connection provides an applied and maintained voltage of about 100 V to about 300 V to the porous first electrode and the second independent electrical connection provides an applied and maintained voltage of about 100 V to about 300 V to the porous second electrode.

Embodiment 56. The method, assembly, or device of any of the above embodiments, the dispersed phase having a conductivity of from about 50,000 μS/cm to about 100,000 μS/cm, the continuous phase having a conductivity of less than 10 μS/cm.

In light of the foregoing, it should be appreciated that the present invention advances the art by providing an improved electrowetting coalescence device and corresponding methods. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### Examples

Examples were run with an embodiment of the electrowetting coalescence device disclosed herein according to these specifics. An emulsion was prepared including a dispersed phase and a continuous phase. Equal volumes (400 mL) of an aqueous solution (i.e., dispersed phase) and an organic solution (i.e., continuous phase) were mixed using a mixer set to a speed of 1750 RPM for 6 minutes. The mixture was allowed to rest for 5 minutes to allow the two phases to separate. The aqueous phase was at the bottom, and the organic will be at the top. The aqueous phase that accumulated at the bottom was decanted, leaving the aqueous-organic emulsion. The decanted volume was about 0.5 L. These steps were repeated until a desired volume of emulsion was reached. These steps were performed again in order to achieve a variety of fluid samples.

For the overall fluid that was provided to the EWC, the concentration of the dispersed aqueous phase in the continuous organic phase was about 3,500+/−20 ppm.

The EWC included two porous layers made of mesh. The inlet and outlet pore sizes were 1 mm. A polymer coating of PMMA and FluoroPel (hydrophobic coating) was utilized. The voltage (V), flow rate (mL/min), temperature (° C.); and gap distance (mm) were adjusted as shown in Table 1. The final concentrations and separation efficiencies are reported. Experiments run at 50 mL/min took 30 minutes to complete and experiments run at 30 mL/min took 50 minutes to complete.

The final separation efficiency in Table 1 is a measure of the effectiveness of the EWC to coalesce fine drops into coarse drops that separate by settling. Efficiency is calculated using Equation (8):

$$Efficiency = \frac{{f}_{o} - f}{{f}_{o}} \times 100 \% \qquad Equation ( 8 )$$

where ƒₒ is the inlet aqueous concentration from the mixing tank and ƒ is the concentration of small drops exiting the EWC, as previously discussed. Said another way, the ƒ is the concentration of small drops that do not settle by gravity.

Based on the above, several experiments (“Exp. #”) were conducted on the electrowetting coalescence device (EWC) to explore the effects of certain parameters, e.g., voltage, flow rate, gap distance, and temperature. The organic process fluid used included an organic acid and a petroleum distillate. Table 1 summarizes Experiments 1 to 30 and provides final concentrations (ppm) and the separation efficiency (%). Table 2 summarizes three experiments done at the center point values of certain parameters. Table 3 summarizes the experimental conditions leading to greatest and smallest separation efficiency.

TABLE 1
Summary of testing parameters for Experiments 1 to 30.

| | | | | | Final | |
|---|---|---|---|---|---|---|
| | | | | Gap | Aq. | Separation |
| | Voltage | Flow Rate | Temp. | distance | Conc. | efficiency |
| Exp. # | (V) | (mL/min) | (C.) | (mm) | (ppm) | (%) |
| 1 | 200 | 50 | 50 | 0.5 | 1295 | 63 |
| 2 | 100 | 30 | 24 | 1.5 | 1540 | 54 |
| 3 | 200 | 50 | 24 | 1.5 | 1820 | 48 |
| 4 | 100 | 50 | 24 | 0.5 | 1855 | 47 |
| 5 | 150 | 40 | 37 | 1 | 875 | 75 |
| 6 | 200 | 50 | 24 | 0.5 | 1645 | 53 |
| 7 | 100 | 30 | 50 | 1.5 | 1330 | 62 |
| 8 | 100 | 30 | 24 | 0.5 | 1225 | 65 |
| 9 | 150 | 40 | 37 | 1 | 595 | 83 |
| 10 | 200 | 30 | 50 | 1.5 | 1120 | 68 |
| 11 | 100 | 50 | 50 | 0.5 | 1570 | 55 |
| 12 | 100 | 50 | 24 | 1.5 | 2100 | 40 |
| 13 | 200 | 30 | 50 | 0.5 | 490 | 86 |
| 14 | 200 | 50 | 50 | 1.5 | 1505 | 57 |
| 15 | 200 | 30 | 24 | 0.5 | 805 | 77 |
| 16 | 100 | 30 | 50 | 0.5 | 840 | 76 |
| 17 | 200 | 30 | 24 | 1.5 | 1330 | 62 |
| 18 | 100 | 50 | 50 | 1.5 | 1925 | 45 |
| 19 | 150 | 40 | 37 | 1 | 770 | 78 |
| 20 | 100 | 40 | 1 | 37 | 1250 | 64 |
| 21 | 200 | 40 | 1 | 37 | 700 | 80 |
| 22 | 150 | 30 | 1 | 37 | 580 | 83 |
| 23 | 150 | 50 | 1 | 37 | 1000 | 71 |
| 24 | 150 | 40 | 0.5 | 37 | 540 | 85 |
| 25 | 150 | 40 | 1.5 | 37 | 1100 | 69 |
| 26 | 150 | 40 | 1 | 24 | 1150 | 67 |
| 27 | 150 | 40 | 1 | 50 | 620 | 82 |
| 28 | 150 | 40 | 1 | 37 | 810 | 77 |
| 29 | 150 | 40 | 1 | 37 | 900 | 74 |
| 30 | 150 | 40 | 1 | 37 | 830 | 76 |

TABLE 2
Summary of experimental conditions at center point values.

| | | | | Average | |
|---|---|---|---|---|---|
| | Flow | | Gap | Final Aq. | Separation |
| Voltage | Rate | Temp. | Distance | Conc. | Efficiency |
| (V) | (ml/min) | (° C.) | (mm) | (ppm) | (%) |
| 150 | 40 | 37 | 1.0 | 875 | 75 |
| 150 | 40 | 37 | 1.0 | 595 | 83 |
| 150 | 40 | 37 | 1.0 | 770 | 78 |

TABLE 3
Summary of experimental conditions leading to greatest and
smallest separation efficiency from the above results.

| | Flow | | Gap | Final Aq. | Separation |
|---|---|---|---|---|---|
| Voltage | Rate | Temperature | distance | Conc. | Efficiency |
| (V) | (ml/min) | (° C.) | (mm) | (ppm) | (%) |
| 100 | 50 | 24 | 1.5 | 2100 | 40 |
| 200 | 30 | 50 | 0.5 | 490 | 86 |

Table 3: Summary of experimental conditions leading to greatest and smallest separation efficiency from the above results.

Table 3 lists the EWC operating conditions for the maximum final separation efficiency achieved for the above results, 86%, corresponding to a final aqueous concentration of 490 ppm exiting the EWC. The minimum separation efficiency for the above results was 4000 corresponding to a final aqueous concentration of 2100 ppm.

As provided in Table 4 below, the test fluid was passed through an EWC three times to mimic three EWC devices in series. After each pass, the aqueous fluid was separated and the test fluid re-ran through the EWC. The EWC was configured as: voltage: 150V; gap distance: 1 mm; flow rate: 40 mL/min; and temperature: 37° C. The test fluid was similar to the above fluid.

TABLE 4
A summary of three passes through a single EWC (in a manner
equivalent to passing through three EWC devices in series).

| 1st pass | | | 2nd pass | | 3rd pass | |
|---|---|---|---|---|---|---|
| | | Sep. | | Sep. | | Sep. |
| Time | Aq. Conc. | Efficiency | Aq. Conc. | efficiency | Aq. Conc. | Efficiency |
| (s) | (ppm) | (%) | (ppm) | (%) | (ppm) | (%) |
| 0 | 3500 | 0 | 970 | — | 710 | — |
| 10 | 2370 | 32% | 840 | 13% | 650 | 8% |
| 20 | 1450 | 59% | 810 | 16% | 630 | 11% |
| 30 | 1050 | 70% | 750 | 23% | 610 | 14% |
| 40 | 900 | 74% | 710 | 27% | 600 | 15% |

Table 5 provides additional testing conducted on the EWC for a different fluid. The test details are similar to above except the initial concentrations for the overall fluid that was provided to the EWC were 1200+/−10 ppm relative to the concentration of the dispersed aqueous phase in the continuous organic phase.

TABLE 5
Summary of additional testing and results.

| | | | | Gap | Final Aq. | Separation |
|---|---|---|---|---|---|---|
| | Voltage | Flow Rate | Temp. | distance | Conc. | Efficiency |
| Exp# | (V) | (mL/min) | (C.) | (mm) | (ppm) | (%) |
| 1 | 200 | 50 | 50 | 0.5 | 390 | 68 |
| 2 | 100 | 30 | 24 | 1.5 | 510 | 58 |
| 3 | 200 | 50 | 24 | 1.5 | 440 | 63 |
| 4 | 100 | 50 | 24 | 0.5 | 550 | 54 |
| 5 | 150 | 40 | 37 | 1 | 230 | 81 |
| 6 | 200 | 50 | 24 | 0.5 | 390 | 68 |
| 7 | 100 | 30 | 50 | 1.5 | 420 | 65 |
| 8 | 100 | 30 | 24 | 0.5 | 410 | 66 |
| 9 | 150 | 40 | 37 | 1 | 210 | 83 |
| 10 | 200 | 30 | 50 | 1.5 | 280 | 77 |
| 11 | 100 | 50 | 50 | 0.5 | 560 | 53 |
| 12 | 100 | 50 | 24 | 1.5 | 710 | 41 |
| 13 | 200 | 30 | 50 | 0.5 | 180 | 85 |
| 14 | 200 | 50 | 50 | 1.5 | 480 | 60 |
| 15 | 200 | 30 | 24 | 0.5 | 270 | 78 |
| 16 | 100 | 30 | 50 | 0.5 | 300 | 75 |
| 17 | 200 | 30 | 24 | 1.5 | 360 | 70 |
| 18 | 100 | 50 | 50 | 1.5 | 560 | 53 |
| 19 | 150 | 40 | 37 | 1 | 190 | 84 |
| 20 | 100 | 40 | 1 | 37 | 320 | 73 |
| 21 | 200 | 40 | 1 | 37 | 210 | 83 |
| 22 | 150 | 30 | 1 | 37 | 190 | 84 |
| 23 | 150 | 50 | 1 | 37 | 350 | 71 |
| 24 | 150 | 40 | 0.5 | 37 | 190 | 84 |
| 25 | 150 | 40 | 1.5 | 37 | 370 | 69 |
| 26 | 150 | 40 | 1 | 24 | 300 | 75 |
| 27 | 150 | 40 | 1 | 50 | 170 | 86 |
| 28 | 150 | 40 | 1 | 37 | 220 | 82 |
| 29 | 150 | 40 | 1 | 37 | 240 | 80 |
| 30 | 150 | 40 | 1 | 37 | 230 | 81 |

Additional samples were run with variable sizes for the outlet pores and the inlet pores. The inlet mesh was varied between 0.7 and 2 mm, and outlet mesh was varied from 0.5 to 1.5 mm.

TABLE 6
Summary of additional testing and results for variable pore sizes.

| Experimental parameter | Value |
|---|---|
| Voltage (V) | 110 |
| Flow Rate (ml/min) | 200 |
| Gap Distance (mm) | 0.5 |
| Temperature (C. °) | 45 |
| Inlet mesh size (mm) | 0.7, 1.35, 2.0 |
| Outlet mesh size (mm) | 0.5, 1.0, 1.5 |

| | Inlet | Outlet | Final Aq. | Separation |
|---|---|---|---|---|
| | Mesh | Mesh | Concentration | efficiency |
| Test # | (mm) | (mm) | (ppm) | (%) |
| 1 | 1.35 | 1 | 324 | 73 |
| 2 | 0.7 | 1 | 285 | 76 |
| 3 | 2 | 0.5 | 555 | 53 |
| 4 | 2 | 1.5 | 402 | 66 |
| 5 | 1.35 | 1 | 334 | 72 |
| 6 | 1.35 | 1.5 | 462 | 61 |
| 7 | 2 | 1 | 451 | 62 |
| 8 | 1.35 | 1 | 322 | 73 |
| 9 | 0.7 | 0.5 | 479 | 60 |
| 10 | 1.35 | 0.5 | 492 | 59 |
| 11 | 0.7 | 1.5 | 241 | 80 |
| 12 | 1.35 | 1 | 331 | 72 |
| 13 | 1.35 | 1 | 326 | 73 |

Additional samples were performed on an EWC with 3 electrodes and compared to an EWC with 2 electrodes. The middle electrode was supplied with a positive charge, and the top and bottom were grounded to allow an electric field to be present between the top and middle electrode, as well as the middle and bottom electrode.

TABLE 7
Summary of additional testing and results
for an EWC with 3 electrodes.

| Factor | Value |
|---|---|
| Voltage (V) | 150 |
| Flow Rate (mL/min) | 100 |
| Gap distance (mm) | 1 mm |
| Electrode pore size | 1 mm |
| Temperature (C.) | 45 |

| | | Separation |
|---|---|---|
| Number of | Final aqueous | efficiency |
| electrodes | concentration | (%) |
| 2 | 688 | 43 |
| 3 | 466 | 61 |

Additional samples were performed on an EWC which was prewet. The prewetting was achieved by adding water upstream of the EWC. After preparing the emulsion and mixing, the emulsion was pumped to the EWC. After 5 minutes, the stirrer was switched off, and 15 mL of aqueous solution was poured in the mixing tank. The aqueous solution, being denser than the organic liquid, settled to the bottom of the tank and was pumped to the EWC. The conditions are shown below. With prewetting, the EWC reached steady state earlier. For the prewet EWC, after about 30 mins, the concentration of aqueous exiting the EWC approached a constant. In a similar EWC without being prewet, the aqueous concentration was still in decline at 50 min. Though the experiment was stopped at 50 min, even more time would have been required for the saturation to approach its plateau. Also, the prewet EWC worked more effectively, as a lower amount of aqueous exited the EWC compared to without prewetting.

TABLE 8
Summary of parameters tested for a prewet EWC.

| Factor | Value |
|---|---|
| Voltage (V) | 150 |
| Flow Rate (mL/min) | 100 |
| Gap distance (mm) | 1.0 |
| Mesh inlet pore size (mm) | 1.0 |
| Mesh outlet pore size (mm) | 1.0 |
| Temp. (C. °) | 45 |

Additional samples were performed for an EWC having perforated plates as the porous layers. The conditions and results are shown below.

TABLE 9
Summary of parameters and results for
an EWC having perforated plates.

| Factor | Range |
|---|---|
| Voltage (V) | 100-300 |
| Flow Rate (ml/min) | 50-200 |
| Gap distance | 0.5-2 |

| | Flow | | Gap | Aqueous | Separation |
|---|---|---|---|---|---|
| | Rate | Voltage | distance | concentration | efficiency |
| Exp # | (mL/min) | (V) | (mm) | (ppm) | (%) |
| 1 | 125 | 200 | 1.25 | 319 | 73 |
| 2 | 200 | 300 | 2 | 440 | 63 |
| 3 | 200 | 100 | 0.5 | 451 | 63 |
| 4 | 50 | 100 | 0.5 | 257 | 79 |
| 5 | 125 | 200 | 1.25 | 326 | 73 |
| 6 | 50 | 300 | 2 | 249 | 79 |
| 7 | 200 | 300 | 0.5 | 507 | 58 |
| 8 | 125 | 200 | 1.25 | 334 | 73 |
| 9 | 50 | 100 | 2 | 450 | 63 |
| 10 | 200 | 100 | 2 | 600 | 50 |
| 11 | 50 | 300 | 0.5 | 324 | 73 |
| 12 | 50 | 200 | 1.25 | 190 | 84 |
| 13 | 200 | 200 | 1.25 | 466 | 61 |
| 14 | 125 | 100 | 1.25 | 426 | 65 |
| 15 | 125 | 300 | 1.25 | 322 | 73 |
| 16 | 125 | 200 | 0.5 | 512 | 57 |
| 17 | 125 | 200 | 2 | 421 | 65 |
| 18 | 125 | 200 | 1.25 | 311 | 74 |
| 19 | 125 | 200 | 1.25 | 268 | 78 |
| 20 | 125 | 200 | 1.25 | 289 | 76 |

Relative to these specific sample data points disclosed herein, and other tested data, a statistical model may be generated by regression analysis and could use the results from the experiments in order to better understand the relationship each parameter (e.g. flowrate, voltage, gap distance, pore size, temperature, etc.) has on the EWC operation. The statistical model can be used to minimize the aqueous concentration in the organic or maximize the separation efficiency.

Relative to the mechanistic model disclosed herein (i.e., relative to Equations (3) through (7) above), certain experimental information is disclosed here. An EWC having no initial liquid hold-up (i.e., saturation) in mesh porous layers was provided. An emulsion was passed through the EWC. As the emulsion flowed through the EWC the saturation increased and the concentration of enlarged drops in the outlet stream increased as the saturation increased, ultimately approaching a steady state performance. By holding constant the geometric and operating parameters, the mechanistic model was developed to evaluate how the EWC performance changed with liquid saturation in the mesh. Evaluation of experimental data showed the capture efficiency and a release coefficient can be fitted to functions of the saturation alone using the equations disclosed herein. The model equations fit well with experimental data, which indicated the model accurately predicts the performance of the EWC. As further disclosed above, parameters E_{O} and n were generally constant with changing operational conditions, whereas parameters b and a varied exponentially with flowrate, and remained about constant with the remaining operating conditions. Three liquids were tested, and the results found for E_{O} and n are provided below.

TABLE 10
Summary of Eₒ and n results for three tested fluids.

| Fluid 1 | Fluid 2 | Fluid 3 |
|---|---|---|
| Eo = 0.3 ± 0.043 | Eo = 0.26 ± 0.053 | Eo = 0.33 ± 0.041 |
| n = 3.21 ± 0.26 | n = 2.92 ± 0.22 | n = 2.62 ± 0.36 |

Various modifications and alterations that do not depart from the scope and spirit of this invention will become apparent to those skilled in the art. This invention is not to be duly limited to the illustrative embodiments set forth herein.

1. An electrowetting coalescing device for coalescing droplets of a dispersed phase within a continuous phase of an organic process fluid, the electrowetting coalescing device comprising
an inlet;
a porous first electrode with a first independent electrical connection thereto, the porous first electrode including a first plurality of pores having a first average pore size;
a porous second electrode with a second independent electrical connection thereto, the porous second electrode including a second plurality of pores having a second average pore size, where the second average pore size is different from the first average pore size;
a voltage applied and maintained to the porous first electrode, where the porous second electrode is at a second voltage different from the voltage applied and maintained to the porous first electrode, where the second voltage is optionally a 0 V ground, thereby creating an electric field between the porous first electrode and the porous second electrode;
an outlet; and
the organic process fluid, the organic process fluid including the dispersed phase within the continuous phase, the continuous phase including an organic fluid loaded with metal, and the dispersed phase including aqueous droplets which optionally include further metal ions or acid salts, the dispersed phase being conductive or non-conductive, the continuous phase having a low conductivity;
the electrowetting coalescing device receiving the organic process fluid, the organic process fluid passing through the inlet, the porous first electrode, the electric field, the porous second electrode, and the outlet, the electrowetting coalescing device thereby coalescing smaller droplets of the dispersed phase into larger droplets of the dispersed phase for subsequent removal of the larger droplets from the continuous phase.

2. The device of claim 1, where the first independent electrical connection provides an applied and maintained voltage of about 50 V to about 500 V to the porous first electrode, and where the second independent electrical connection is a connection to a ground such that the porous second electrode has 0 V.

3. The device of claim 1, further comprising a porous third electrode, the porous third electrode positioned as a middle electrode between the porous first electrode and the porous second electrode, the porous third electrode having a third independent electrical connection thereto, the porous third electrode being at a third voltage different from the voltage applied and maintained to the porous first electrode and different from the second voltage.

4. The device of claim 3, where the porous first electrode and the porous second electrode have 0 V, and where the third independent electrical connection provides an applied and maintained voltage of about 50 V to about 500 V to the porous third electrode.

5. The device of claim 3, where the first independent electrical connection provides an applied and maintained voltage of about 50 V to about 500 V to the porous first electrode and the second independent electrical connection provides an applied and maintained voltage of about 50 V to about 500 V to the porous second electrode, and where the porous third electrode has 0 V.

6. The device of claim 1, where the porous first electrode, the porous second electrode, and the porous third electrode are wire mesh and/or perforated plates.

7. (canceled)

8. The device of claim 1, the first average pore size being defined by a first plurality of pores having a substantially constant pore size and/or the second average pore size being defined by a second plurality of pores having a substantially constant pore size.

9. (canceled)

10. The device of claim 1, the first average pore size being defined by a first plurality of pores having different pore sizes, and/or the second average pore size being defined by a second plurality of pores having different pore sizes.

11.-14. (canceled)

15. The device of claim 1, where the porous first electrode and the porous second electrode are each coated with a coating, where the coating includes a dielectric coating layer and a hydrophobic coating layer on the dielectric coating layer.

16.-21. (canceled)

22. The device of claim 3, where one or more of the porous first electrode, the porous second electrode, and the porous third electrode has a pore size ranging from about 0.1 millimeters to about 3 millimeters.

23. The device of claim 3, where a gap distance between respective ones of the porous first electrode, the porous second electrode, and the porous third electrode ranges from about 0.25 mm to about 5 mm.

24.-27. (canceled)

28. The device of claim 1, where the organic process fluid is chosen from one or more of industrial organic chemical products; industrial organic chemical processing fluids; mining and extraction processing fluids; petroleum refining fluids; hydrometallurgy and solvent extraction processing fluids; battery material processing fluids; and battery recycling processing fluids.

29. The device of claim 1, where the organic process fluid is a metal loaded organic fluid.

30. (canceled)

31. The device of claim 1, where the continuous phase is a relatively non-polar liquid with respect to a polarity of the dispersed phase, where the relatively non-polar liquid comprises one or more of metal ions and metal ion complexes, where the relatively non-polar liquid comprises one or more of carboxylic acids, amines, aldehydes, ketones, and alcohols.

32. (canceled)

33. (canceled)

34. The device of claim 1, where the dispersed phase is a relatively polar liquid with respect to a polarity of the continuous phase, where the relatively polar liquid comprises one or more of water, alcohols, acid salts, and metal salts.

35. The device of claim 1, the dispersed phase having a conductivity of from about 1 μS/cm to about 150,000 μS/cm, the continuous phase having a conductivity of less than 100 μS/cm.

36. (canceled)

37. (canceled)

38. (canceled)

39. A method for coalescing droplets of a dispersed phase within a continuous phase of an organic process fluid in an electrowetting coalescing device, the method comprising steps of
providing the electrowetting coalescing device;
providing the organic process fluid, the organic process fluid including the dispersed phase within the continuous phase, the continuous phase including an organic fluid loaded with metal, and the dispersed phase including aqueous droplets which optionally include further metal ions or acid salts, the dispersed phase being conductive or non-conductive, the continuous phase having a low conductivity;
allowing the organic process fluid to flow through the electrowetting coalescing device;
allowing the droplets of the dispersed phase to electrowet to form larger droplets; and
removing the larger droplets from the continuous phase.

40.-50. (canceled)

51. A method of designing an electrowetting coalescing device, the method comprising steps of
providing an organic process fluid, the organic process fluid including a dispersed phase within a continuous phase, the continuous phase including an organic fluid loaded with metal, and the dispersed phase including aqueous droplets which optionally include further metal ions or acid salts;
providing a mechanistic model, where the mechanistic model comprises:
$$\frac{dS}{dt} = ( {c}_{o} + {f}_{o} E ) \frac{Q}{ρ V} - \frac{RQ}{V} \qquad Equation ( 3 )$$
$$f = {f}_{o} - {f}_{o} E \qquad Equation ( 4 )$$
$$c = {c}_{o} + {f}_{o} E \qquad Equation ( 5 )$$
$$E = a S + {E}_{o} \qquad Equation ( 6 )$$
$$R = b {S}^{n} , \qquad Equation ( 7 )$$
where E is the capture efficiency of the electrowetting coalescing device and represents an effectiveness at which smaller droplets are converted into larger droplets for collection thereof, R is a release coefficient and represents an ability of the larger droplets to release from the electrowetting coalescing device, S is a water saturation content, and a, E_{O}, b, and n are fitted parameters;
where Q is a volumetric flow rate through the EWC, V is a volume of the EWC, and ρ is a mass density of the dispersed phase;
where concentrations of the smaller droplets and the larger droplets drops entering the EWC are ƒₒ and cₒ, and concentrations of the smaller droplets and the larger droplets drops exiting the EWC are ƒ and c; and
manufacturing the desired electrowetting coalescing device based on the mechanistic model and properties of the predetermined organic process fluid.

52. The method of claim 51, where E_{O} is 0.30+/−0.05, and where n=2.9+/−0.4.

53. The method of claim 51, further comprising a step of determining a and b based on empirically fitting different flow rates of the organic process fluid with the mechanistic model.

54.-56. (canceled)
